(19) United States
(12) Patent Application Publication
(10) Pub. No.: US 2016/0048842 A1
(43) Pub. Date: Feb. 18, 2016

(54) SYSTEM AND METHOD FOR FINANCIAL TRANSFERS FROM A FINANCIAL ACCOUNT USING SOCIAL MEDIA

(71) Applicant: Capital One Financial Corporation, McLean, VA (US)

(72) Inventors: Dwij TRIVEDI, North Bethesda, MD (US); Michael KIERNAN, Fairfax, VA (US); Anant SAJNANI, McLean, VA (US); Gabe B. GINDELE, Herndon, VA (US)

(21) Appl. No.: 14/827,625

(22) Filed: Aug. 17, 2015

Related U.S. Application Data
(60) Provisional application No. 62/037,715, filed on Aug. 15, 2014.

(51) Int. Cl. G06Q 30/00

(52) U.S. Cl. CPC G06Q 30/016; G06Q 50/01

(57) ABSTRACT

A system and method includes a communication interface of a customer service system that receives, via a network, a request from a customer device to link a social media account and at least one customer device with the customer service system, a social linking application programming interface that enables a social network system to interact with the customer service system and links the customer device to the social media account, a database that stores the link between the customer device and the social media account, a location detector that detects the at least one linked customer device when the at least one customer device is within a predetermined range of a customer service device associated with the customer service system, an alert system that generates a notification based on the customer device being within a predetermined range of the customer service device, a processor that interacts with the social linking application programming interface analyzes the linked social media account to determine at least one customer interest and generate a listing of customer service offers based on the at least one customer interest. The alert system automatically provides at least one of the customer service offers to the customer device.

### CROSS REFERENCE TO RELATED APPLICATIONS

This application contains subject matter related to and claims the benefit of U.S. Provisional Patent Application No. 62/037,715, filed on Aug. 15, 2014, the entire contents of which is incorporated herein by reference.

This application contains subject matter related to U.S. patent application Ser. No. 14/031,263 entitled “System and Method for Determining Social Statements,” U.S. Provisional Patent Application No. 61/737,399 entitled “System and Method for Synching a Financial Account with a Social Network Account,” and U.S. Provisional Patent Application No. 61/924,727, entitled “System and Method for Fraud Detection Using Social Media,” the contents of which are incorporated by reference in their entirety.

This application contains subject matter related to U.S. Pat. No. 7,934,639 entitled “System and method of notifying user near point of sale location of available rewards at the point of sale location”, the contents of which is incorporated by reference in its entirety.

### FIELD OF THE DISCLOSURE

The present disclosure relates to a system and method for providing a customer's financial information to a financial institution device based on location triggers associated with a customer.

### BACKGROUND OF THE DISCLOSURE

Currently, when an individual enters a facility associated with a financial institution, the employees have no way of knowing who the individual is or what an individual may be interested in unless and until that individual approaches the banking employee and provides some form of identification and/or information to shown that he or she is a pre-existing account holder in need of assistance. This makes personalized services difficult. These and other drawbacks exist.

### BRIEF DESCRIPTION OF THE DRAWINGS

Various embodiments of the present disclosure, together with further objects and advantages, may best be understood by reference to the following description taken in conjunction with the accompanying drawings, in the several Figures of which like reference numerals identify like elements, and in which:

FIG. 1 depicts an example embodiment of a system for generating personalized notifications at a financial institution device based on an account holder's detected proximity using a social media platform according to an embodiment of the disclosure;

FIG. 2 depicts an example embodiment of a system for generating personalized notifications at a financial institution device based on an account holder's detected proximity using a social media platform according to an embodiment of the disclosure;

FIG. 3 depicts an example embodiment of a personalized notifications at a financial institution device based on an account holder's detected proximity using a social media platform according to an embodiment of the disclosure;

FIG. 4 depicts an example embodiment of a personalized notifications fat a financial institution device based on an account holder's detected proximity using a social media platform according to an embodiment of the disclosure; and

FIG. 5 depicts an example flow chart illustrating a method for generating personalized notifications at a financial institution device based on an account holder's detected proximity using a social media platform according to an embodiment of the disclosure.

### DETAILED DESCRIPTION OF THE EMBODIMENTS

The following description is intended to convey a thorough understanding of the embodiments described by providing a number of specific example embodiments and details involving systems and methods for providing personalized services to banking customers based on location-based triggers from a mobile device. It should be appreciated, however, that the present disclosure is not limited to these specific embodiments and details, which are exemplary only. It is further understood that one possessing ordinary skill in the art, in light of known systems and methods, would appreciate the use of the invention for its intended purposes and benefits in any number of alternative embodiments, depending on specific design and other needs. A social media system, account provider system, merchant system, and/or account holder device, and system supporting a connection between social media systems, financial account provider systems, merchant systems, and/or mobile devices, are used as examples for the disclosure. The disclosure is not intended to be limited to social media systems, account provider systems, financial institution, and/or mobile devices only.

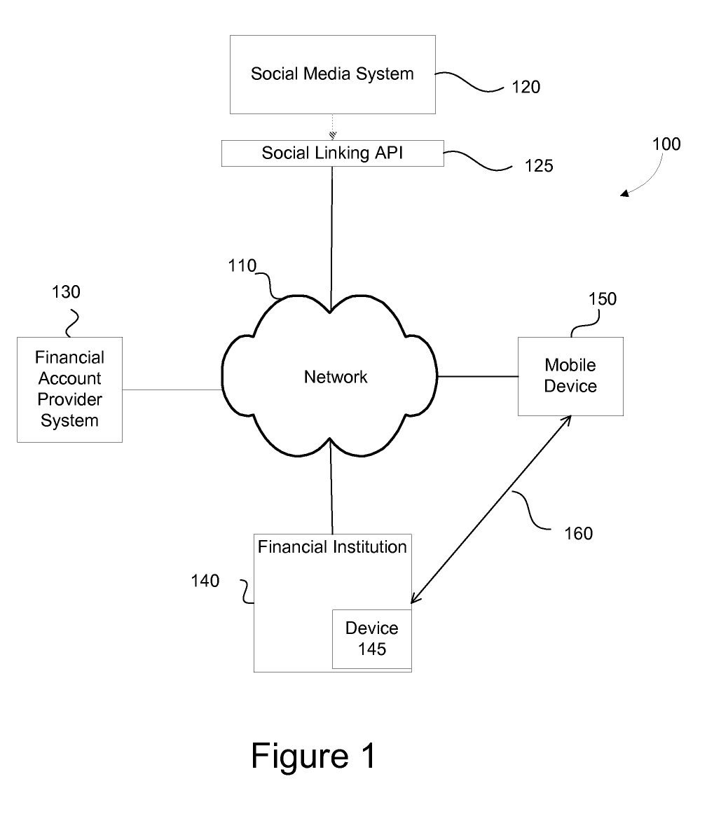

FIG. 1 depicts an example embodiment of a system for providing personalized services to an account holder at a financial institution 100. The system 100 may include various systems connected to each other over a network 110. These systems include a social media system 120, a social linking application programming interface (“API”) 125, an account provider system 130, a financial institution 140, and a mobile device 150.

The network 110 may be one or more of a wireless network, a wired network, or any combination of a wireless network and a wired network. For example, network 110 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 110 may include, without limitation, telephone lines, fiber optics, IEEE Ethernet 902.3, a wide area network (WAN), a local area network (LAN) or a global network such as the Internet. Also, network 110 may support an Internet network, a wireless communication network, a cellular network, or the like, or any combination thereof. Network 110 may further include one network, or any number of example types of networks mentioned above, operating as a stand-alone network or in cooperation with each other. Network 110 may utilize one or more protocols of one or more network elements to which they are communicatively couples. Network 110 may translate to or from other protocols to one or more protocols of network devices. Although network 110 is depicted as a single network, it should be appreciated that according to one or more embodiments, network 110 may comprise a plurality of interconnected networks, such as, for example, the Internet, a service provider's network, a cable television network, corporate networks, and home networks.

A social media provider may access network 110 through one or more social media systems 120 that may be communicatively coupled to the network 110. An account provider, such as a financial institution, may access the network 110 through one or more financial account providers systems 130 that may be communicatively coupled to the network 110. One or more banking locations 140 may be communicatively coupled to the network 110. Additionally, one or more social media subscribers and/or account holders may be communicatively coupled to the network 110 through a mobile device 150. Although social media system 120, account provider system 130, banking location 140, and mobile device 150 are depicted as a single systems and/or devices, it should be appreciated that according to one or more embodiments, mobile social media system 120, account provider system 130, banking location 140, and mobile device 150 may comprise a plurality of systems and/or devices. Moreover, mobile device 150 may also include any other form of computing device described below, at which a subscriber and/or account holder may access network 110. Mobile device 150 may use various software and hardware components to access social media system and/or financial account system.

An example social media system 120, account provider system 130, financial institution 140, and/or mobile device 150 may include one or more network-enabled computers to process instructions for methods for detecting a location of mobile device 150 relative to financial institution 140, providing personalized information to a device associated with financial 140 about the customer associated with mobile device 150, and suggesting personalized services for that customer.

As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 100 may execute one or more software applications of location detection and personalized service.

The social media system 120, account provider system 130, financial institution 140, and/or mobile device 150 may further include, for example, a processor, which may be several processors, a single processor, or a single device having multiple processors. The social media system 120, account provider system 130, financial institution 140, and/or mobile device 150 may store information in various electronic storage media, such as, for example, a database (not shown) and/or other data storage. Electronic information may be stored in the application social media system 120, account provider system 130, financial institution 140, and/or mobile device 150 in a format such as, for example, a flat file, an indexed file, a hierarchical database, a post-relational database, a relational database, such as a database created and maintained with software from, for example Oracle® Corporation, Microsoft® Excel file, Microsoft® Access file, or any other storage mechanism.

The social media system 120, account provider system 130, financial institution 140, and/or mobile device 150 may send and receive data using one or more protocols. For example, data may be transmitted and received using Wireless Application Protocol (WAP), Multimedia Messaging Service (MMS), Enhanced Messaging Service (EMS), Short Message Service (SMS), Global System for Mobile Communications (GSM) based systems, Time Division Multiplexing (TDM) based systems, Code Division Multiples Access (CDMA) based systems suitable for transmitting and receiving data. Data may be transmitted and received wirelessly or may utilize cabled network connections or telecom connections, fiber connections, traditional phone wireline connection, a cable connection, or other wired network connection.

Each social media system 120, account provider system 130, financial institution 140, and/or mobile device 150 of FIG. 1 also may be equipped with physical media, such as, but not limited to, a compact disc (CD), a digital versatile disc (DVD), a floppy disk, a hard drive, read only memory (ROM), random access memory (RAM), as well as other physical media capable of storing software, or combinations thereof. Social media system 120, account provider system 130, financial institution 140, and/or mobile device 150 may be able to perform the functions associated with methods described herein. Social media system 120, account provider system 130, financial institution 140, and/or mobile device 150 may, for example, house the software for methods of providing personalized services to banking customers based on the customer's detected location relative to a banking location and received social media data, obviating the need for a separate device on the network 110 to run the methods housed on social media system 120, account provider system 130, financial institution 140, and/or mobile device 150.

Furthermore, the information stored in a database (not shown) may be available over the network 110, with the network containing data storage. A database housed on social media system 120, account provider system 130, financial institution 140, mobile device 150, and/or the network 110, may store, or may connect to external data warehouses that stores, account holder data, social media subscriber data, and/or funds transfer data.

The example embodiments disclosed herein are directed to systems and methods for providing personalized services to customers based on the location of the customer relative to a financial institution, and the like. Example financial institutions may include, Capital One, Bank of America, Wells Fargo, Citibank, community banks, and the like. Financial institution 140 may include one or more ATMs and windows where banking customers can receive personal service from a banking employee. Devices 145 associated with a financial institution may include devices associated with a location, such as a mobile device associated with a financial institution employee, a kiosk located at a financial institution, and/or any other computing device having access to financial account provider system 130. Device 145 may be a network-enabled computer and/or may be operated by an employee of a financial institution 140.

According to the various embodiments of the present disclosure, social media system 120 may include a system associated with a social media provider, such as Facebook, Twitter, MySpace, Foursquare, Instagram, Google+, LinkedIn, and the like. Each social media system 120 may house subscriber accounts holding account data, such as, for example, subscriber name, subscriber phone number, subscriber address, subscriber occupation, and/or subscriber location information. As used herein a “subscriber” is one associated with a social media system and an “account holder” is one associated with a financial account provider system.

Subscriber accounts may also include social data. Social data may comprise, at least, preference data, profile data, geo-social data, and/or event data associated with the subscriber account.

Preference data may include data from a subscriber's social networking profile indicating the subscriber's approval of particular content. For example, an subscriber, while accessing his account at social media system 120, may “like” pictures, videos, articles, social media pages, movies, TV shows, bands, brands, restaurants, comments, and other content posted on the social networking site. Preference data may include data indicating privacy preferences associated with the social media account, such as for example, a preference to transmit subscriber profile data, a preference to receive data from third party systems, and/or a preference to display data.

Profile information may include the subscriber's date of birth, hometown, current occupation, employment history, current location, educational history, relationship status, favorite quotes, social relationships (friends, family members, co-workers), information about different groups that the subscriber is a part of, favorite TV shows, movies, books, games, sport's teams, and similar data. Geo-social data may include location-based information provided by the subscriber on their account. The subscriber may “check-in” at a location, indicating that the subscriber is currently or was recently at that location. Geo-social data may include GPS coordinates corresponding to the subscriber's location. Geo-social data may include the name of the location (e.g., a restaurant, concert venue, tourist attraction, club, etc.), a physical address, and other descriptive information. Geo-social data may include names and profile information for other users who were with the subscriber at the location. Event data may include major life events and/or status updates that the subscriber added to the account, including a new job, an engagement, graduation, a move, birth of a child, a marriage, a new relationship, a pay raise, or other events.

According to the various embodiments of the present disclosure, a system and method for providing personalized services to banking customers based on location-based triggers from a mobile device may further include linking a social media subscriber account held with the social media system to a financial account held with an account provider system. U.S. patent application Ser. No. 14/031,263 entitled “System and Method for Determining Social Statements,” U.S. Provisional Patent Application No. 61/737,399 entitled “System and Method for Synching a Financial Account with a Social Network Account,” and U.S. Provisional Patent Application No. 61/924,727, entitled “System and Method for Fraud Detection Using Social Media,” each disclose systems and methods relating to social media accounts associated with financial accounts, the contents of which are incorporated by reference in their entirety.

Mobile device 150 may be associated with an account holder having a financial account associated with financial account provider system 130. The account holder may also be a subscriber with social media system 120. The subscriber may access an application on mobile device 150 to link his financial account with his social media account (e.g., by opting-in for the service). The application may be part of a mobile banking application provided by financial account provider system 130. Linking social media system 120 with account provider system 130 may include receiving, at the social media system, account details of the account holder's financial account held at account provider system 130 and/or receiving, at the account provider system 130, account details of the account holder's subscriber account held at social media system 120. The linking process may include an opt-in process. For example, a financial account holder may opt-in and allow the financial account provider to access data held at a social media system associated with the account holder. The account holder may opt-in using one or more applications on his mobile device. The applications may be part of a mobile banking application provided by the account provider. Additionally, the social media subscriber may opt-in and allow the social media system to access data held at a financial account provider system associated with the subscriber. The social media subscriber also may opt-in and allow the social media system to provide data to the financial account provider system to enable fraud detection. Data provided by the social media system may include location data and/or social media preference data, including privacy preferences associated with the social media account. Moreover, the linking process may occur through social linking application programming interface (“API”) 125.

Social linking API 125 may allow certain data to be transmitted through the API so that social media system 120 may communicate with account provider system 130. The social linking API 125 may prevent data other than approved data to be transmitted through the API. Social linking API 125 may allow social data from the subscriber account to be transmitted to financial account provider system 130. Social linking API 125 may restrict the type of data transmitted from social media system 120 to financial account provider system 130. For example, the API may only support subscriber name, subscriber e-mail address, subscriber identification information, and subscriber location information to be transmitted from social media system 120 to the account provider system 130. Also, the social linking API may allow subscriber relationship data to be transmitted to account provider system 130 if the subscriber/account holder opts-in to allow relationship data to be provided to the account provider system 130.

Social linking API 125 may provide encryption and filtering functionality to prevent, for example, identity theft and fraudulent transactions. For example, the social linking API 125 may filter out personally identifying information that is unnecessary to carry out the claimed methods, such as, social security numbers. Social linking API 125 may also encrypt, for example, account and routing numbers to ensure that any passing account identifying data is secure during transmission and storage.

Once a financial account and social media account are linked, the account holder may enter a location associated with a financial institution with a mobile device. Location data from mobile device 150 may be transmitted to financial account provider system 130 via network 110. The location data may be GPS coordinates, Assisted GPS (A-GPS) data, geo-magnetic data, IP address data, cell tower data, Wi-Fi access point signals, additional Wi-Fi signal data, device-to-device technology data(e.g., RFID transceiver data, NFC data, Bluetooth data and/or iBeacon data) and/or any combination of the above (e.g., crowd-sourced positioning data).

Systems and methods for transmitting location data from a mobile device are more fully described in U.S. Pat. No. 7,934,639 entitled “System and method of notifying user near point of sale location of available rewards at the point of sale location”, the contents of which is incorporated by reference in its entirety. Financial account provider system 130 may compare the location data of mobile device 150 to the location of a financial institution 140. If the location data indicates that mobile device 150 is within some predetermined distance of financial institution 140, financial account provider system 130 may provide one or more alerts to financial institution 140. This predetermined distance may be set so that it is only triggered when the location of mobile device 150 effectively co-resides with financial institution 140, indicating to financial account provider system 130 that the user of mobile device 150 has entered the financial institution 140.

Mobile device 150 may be, for example, a handheld PC, a phone, a smartphone, a PDA, a tablet computer, or other device. Mobile device 150 may include device-to-device communication abilities (shown as element 160). Mobile device 150 may transmit its location directly to financial institution 140 and/or financial institution 140 may detect the presence of mobile device 150 via element 160. Element 160 may include RFID transmitters and receivers, cameras, scanners, and/or Near Field Communication (NFC) devices, which may allow for communication with other devices by touching them together or bringing them into close proximity. Exemplary NFC standards include ISO/IEC 18092:2004, which defines communication modes for Near Field Communication Interface and Protocol (NFCIP-1). Element 160 may use Bluetooth technology built into mobile device 150 and devices and sensors located at banking location 140. Element 160 may comprise iBeacon technology and/or Bluetooth Low Energy (BLE) technology.

The location data from mobile device 150 may also include an identifier associated with the account holder. The identifier may be an account number, name, phone number, and/or other data that uniquely identifies the account holder. Once financial account provider system 130 and/or financial institution 140 determines that mobile device 150 has entered a premise associated with a financial institution 140 (based on the location data), one or more terminals 145 at financial institution 140 may receive account data and/or social data associated with the account holder. The account data and/or social data may be received from financial account provider system 130 and/or social media system 120 (via social linking API 125). The one or more devices 145 may be associated with employees of financial institution 140. The one or more devices may be network enabled computers. At least one of the one or more devices may be a mobile device. The one or more devices may be configured to access network 110.

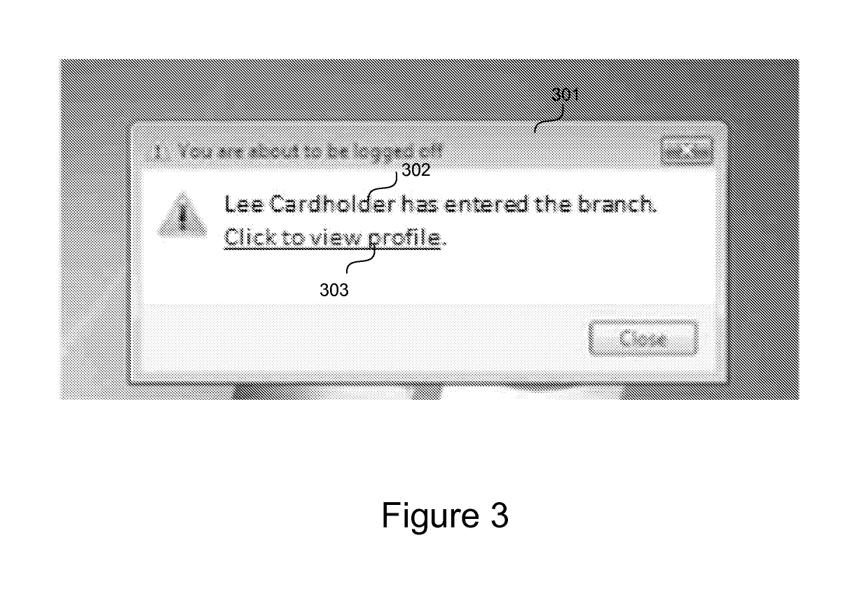

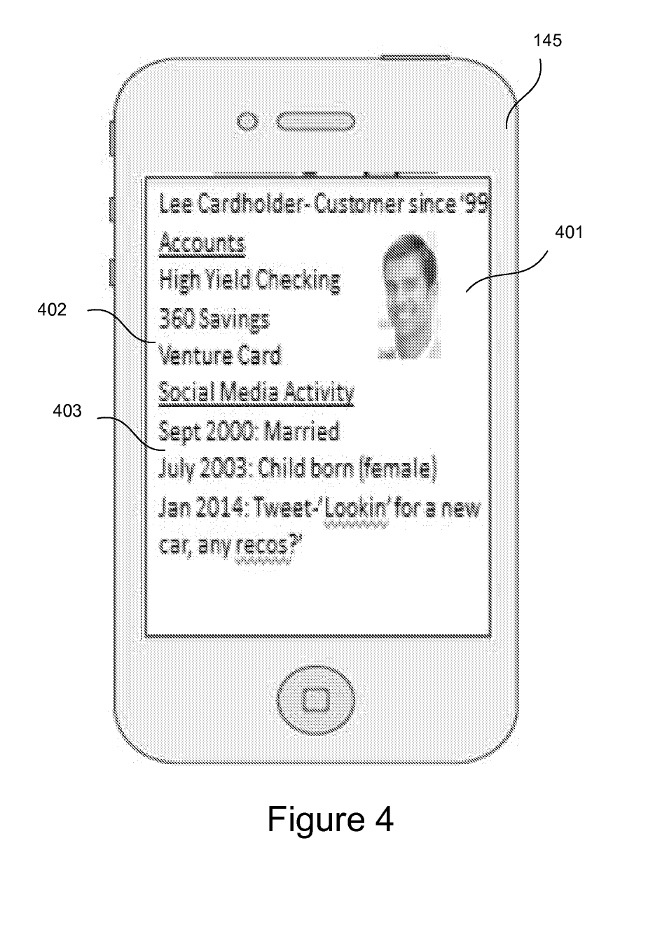

Device 145 may receive a notification, informing the device operator that the account holder has entered the premises of financial institution 140. An embodiment of a notification 301 is shown in FIG. 3. The notification 301 may include, for example, account holder data such as the name of the account holder 302. The notification may include one or more interactive features (e.g., link 303) allowing the terminal 145 operator to view personalized information about the account holder. The personalized information may be based on account data and/or social data received at banking location 140 in response to the detected location of mobile device 150. If the terminal operator elects to view the profile, terminal 145 may receive a second notification. An embodiment of the second notification is shown in FIG. 4.

FIG. 4 shows an embodiment of a second notification 401 received at device 145. The second notification 401 may include personalized information 402 about the account holder associated with mobile device 150. The second notification may include, for example, the account holder's name (in this example, “Lee Cardholder”). The second notification may be based on account data from financial account provider system 130. The account data may include the date the account holder first opened his account, the types of accounts, account balances, account terms, any credit limits associated with the accounts, available rewards points, and the like.

The second notification 301 may also include social data 403. The social data 403 may include preference data, profile data, status updates, geo-social data, and/or event data. For example, in the embodiment shown in FIG. 4, the second notification informs the operator of device 145 that Lee Cardholder has been married since 2000 (profile data) , has one child born in 2003 (event data and/or profile data), and recently included a tweet about looking for a new car (status update and/or event data). The second notification may also include a photo of the account holder (from the social data) so that the operator can easily identify the account holder and approach him to offer personalized services.

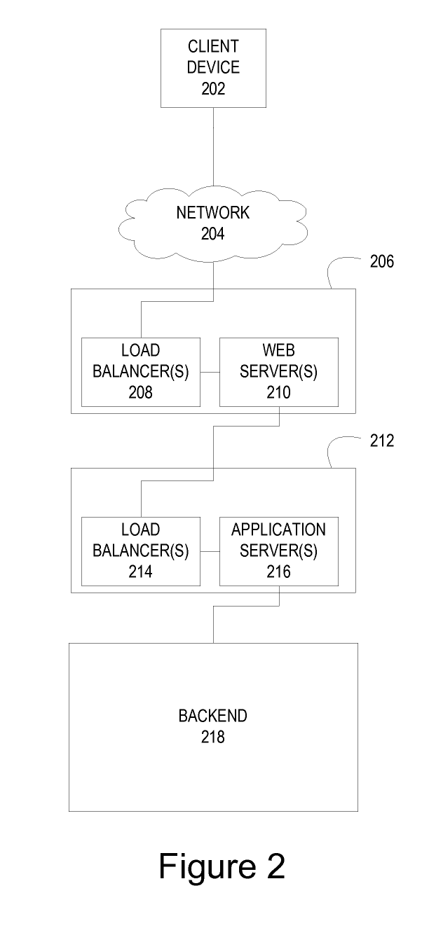

FIG. 2 depicts an example system 200 that may enable a financial services provider to provide individualized services to an account holder based on the account holder's location. As shown in FIG. 2, system 200 may include a client device 202, a network 204, a front-end controlled domain 206, a back-end controlled domain 212, and a backend 218. Front-end controlled domain 206 may include one or more load balancers 208 and one or more web servers 210. Back-end controlled domain 212 may include one or more load balancers 214 and one or more application servers 216.

Client device 202 may be a network-enabled computer. Client device 202 may be similar to mobile device 150 and/or device 145. As referred to herein, a network-enabled computer may include, but is not limited to: e.g., any computer device, or communications device including, e.g., a server, a network appliance, a personal computer (PC), a workstation, a mobile device, a phone, a handheld PC, a personal digital assistant (PDA), a thin client, a fat client, an Internet browser, or other device. The one or more network-enabled computers of the example system 200 may execute one or more software applications to enable, for example, network communications.

Client device 202 also may be a mobile device: For example, a mobile device may include an iPhone, iPod, iPad from Apple® or any other mobile device running Apple's iOS operating system, any device running Google's Android® operating system, including for example, Google's wearable device, Google Glass, any device running Microsoft's Windows® Mobile operating system, and/or any other smartphone or like wearable mobile device.

Network 204 may be one or more of a wireless network, a wired network, or any combination of a wireless network and a wired network. For example, network 204 may include one or more of a fiber optics network, a passive optical network, a cable network, an Internet network, a satellite network, a wireless LAN, a Global System for Mobile Communication (GSM), a Personal Communication Service (PCS), a Personal Area Networks, (PAN), D-AMPS, Wi-Fi, Fixed Wireless Data, IEEE 802.11b, 802.15.1, 802.11n, and 802.11g or any other wired or wireless network for transmitting and receiving a data signal.

In addition, network 204 may include, without limitation, telephone lines, fiber optics, IEEE Ethernet 902.3, a wide area network (WAN), a local area network (LAN) or a global network such as the Internet. Also, network 204 may support an Internet network, a wireless communication network, a cellular network, or the like, or any combination thereof. Network 204 may further include one network, or any number of example types of networks mentioned above, operating as a stand-alone network or in cooperation with each other. Network 204 may utilize one or more protocols of one or more network elements to which they are communicatively couples. Network 204 may translate to or from other protocols to one or more protocols of network devices. Although network 204 is depicted as a single network, it should be appreciated that according to one or more embodiments, network 204 may comprise a plurality of interconnected networks, such as, for example, the Internet, a service provider's network, a cable television network, corporate networks, and home networks.

Front-end controlled domain 206 may be implemented to provide security for backend 218. Load balancer(s) 208 may distribute workloads across multiple computing resources, such as, for example computers, a computer cluster, network links, central processing units or disk drives. In various embodiments, load balancer(s) 208 may distribute workloads across, for example, web server(S) 210 and/or backend 218 systems. Load balancing aims to optimize resource use, maximize throughput, minimize response time, and avoid overload of any one of the resources. Using multiple components with load balancing instead of a single component may increase reliability through redundancy. Load balancing is usually provided by dedicated software or hardware, such as a multilayer switch or a Domain Name System (DNS) server process.

Load balancer(s) 208 and 214 may include software that monitoring the port where external clients, such as, for example, client device 202, connect to access various services of a financial institution or third party that provides the social cash services (such as system 100 shown in FIG. 1), for example. Load balancer(s) 208 may forward requests to one of the application servers 216 and/or backend 218 servers, which may then reply to load balancer 208. This may allow load balancer(s) 208 to reply to client device 202 without client device 202 ever knowing about the internal separation of functions. It also may prevent client devices from contacting backend servers directly, which may have security benefits by hiding the structure of the internal network and preventing attacks on backend 218 or unrelated services running on other ports, for example.

A variety of scheduling algorithms may be used by load balancer(s) 208 to determine which backend server to send a request to. Simple algorithms may include, for example, random choice or round robin. Load balancers 208 also may account for additional factors, such as a server's reported load, recent response times, up/down status (determined by a monitoring poll of some kind), number of active connections, geographic location, capabilities, or how much traffic it has recently been assigned.

Load balancers 208 may be implemented in hardware and/or software. Load balancer(s) 208 may implement numerous features, including, without limitation: asymmetric loading; Priority activation: SSL Offload and Acceleration; Distributed Denial of Service (DDoS) attack protection; HTTP compression; TCP offloading; TCP buffering; direct server return; health checking; HTTP caching; content filtering; HTTP security; priority queuing; rate shaping; content-aware switching; client authentication; programmatic traffic manipulation; firewall; intrusion prevention systems.

Web server(s) 210 may include hardware (e.g., one or more computers) and/or software (e.g., one or more applications) that deliver web content that can be accessed by, for example a client device (e.g., client device 202) through a network (e.g., network 204), such as the Internet. In various examples, web servers, may deliver web pages, relating to, for example, online banking applications and the like, to clients (e.g., client device 202). Web server(s) 210 may use, for example, a hypertext transfer protocol (HTTP or sHTTP) to communicate with client device 202. The web pages delivered to client device may include, for example, HTML documents, which may include images, style sheets and scripts in addition to text content.

A user agent, such as, for example, a web browser, web crawler, or native mobile application, may initiate communication by making a request for a specific resource using HTTP and web server 210 may respond with the content of that resource or an error message if unable to do so. The resource may be, for example a file on stored on backend 218. Web server(s) 210 also may enable or facilitate receiving content from client device 202 so client device 202 may be able to, for example, submit web forms, including uploading of files.

Web server(s) also may support server-side scripting using, for example, Active Server Pages (ASP), PHP, or other scripting languages. Accordingly, the behavior of web server(s) 210 can be scripted in separate files, while the actual server software remains unchanged.

Load balancers 214 may be similar to load balancers 208 as described above.

Application server(s) 216 may include hardware and/or software that is dedicated to the efficient execution of procedures (e.g., programs, routines, scripts) for supporting its applied applications. Application server(s) 216 may comprise one or more application server frameworks, including, for example, Java application servers (e.g., Java platform, Enterprise Edition (Java EE), the .NET framework from Microsoft®, PHP application servers, and the like). The various application server frameworks may contain a comprehensive service layer model. Also, application server(s) 216 may act as a set of components accessible to, for example, a financial institution or other entity implementing system 200 and/or system 100, through an API defined by the platform itself. For Web applications, these components may be performed in, for example, the same running environment as web server(s) 210, and application servers 216 may support the construction of dynamic pages. Application server(s) 216 also may implement services, such as, for example, clustering, fail-over, and load-balancing. In various embodiments, where application server(s) 216 are Java application servers, the web server(s) 210 may behaves like an extended virtual machine for running applications, transparently handling connections to databases associated with backend 218 on one side, and, connections to the Web client (e.g., client device 202) on the other.

Backend 218 may include hardware and/or software that enables the backend services of, for example, a financial institution or other entity that maintains a distributed system similar to system 200 and/or system 100. For example, backend 218 may include, a system of record, online banking applications, a rewards platform, a payments platform, a lending platform, including the various services associated with, for example, auto and home lending platforms, a statement processing platform, one or more platforms that provide mobile services, one or more platforms that provide online services, a card provisioning platform, a general ledger system, a system for providing customer-specific data (e.g., system 100 shown in FIG. 1) and the like. Backend 218 may be associated with various databases, including account databases that maintain, for example, customer account information, product databases that maintain information about products and services available to customers, content databases that store content associated with, for example, a financial institution, and the like. Backend 218 also may be associated with one or more servers that enable the various services provided by system 200. Backend 218 may be associated with one or more servers that enable the various services provided by system 100.

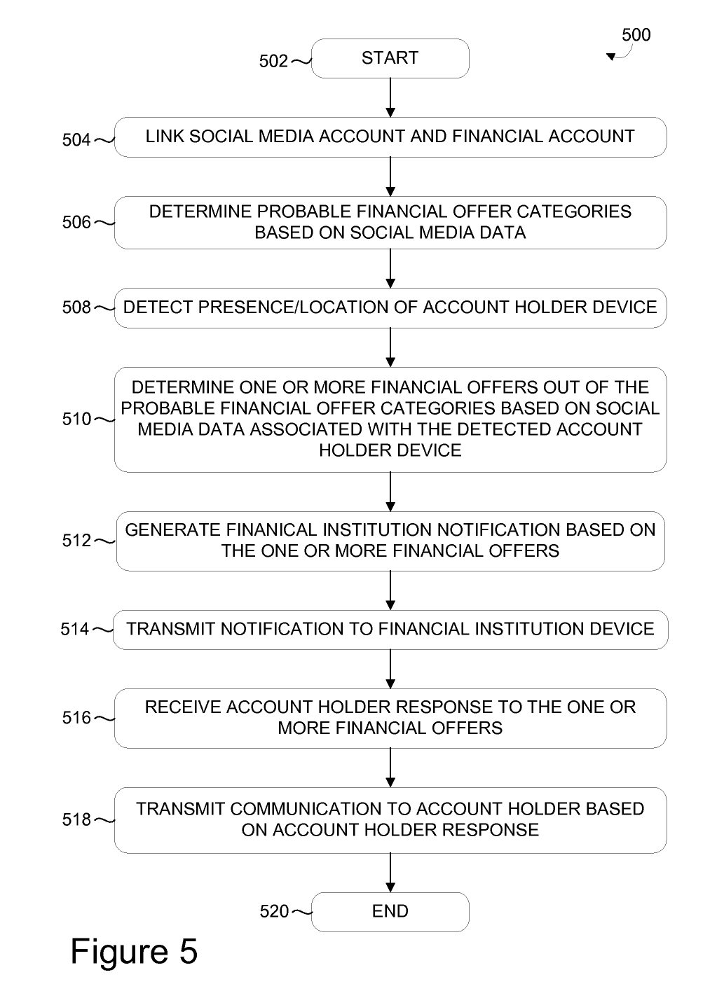

FIG. 5 illustrates a method for generating personalized notifications to a financial institution device based on the detected proximity of an account holder device. The method 500 may begin at step 502. At step 504, a financial account holder may link a social media account to the financial account. Step 504 also may include a social media account holder linking a financial account to the social media account. A linking of accounts may be facilitated by a social linking API.

A social linking API may allow certain data to be transmitted through the API so that a social media system may communicate with a financial account provider system. The social inking API may format data to be transmitted between a social media system and a financial account provider system. The social linking API also may prevent data other than approved data to be transmitted through the API. For example, the API may only support subscriber name, subscriber e-mail address, subscriber identification information, and subscriber location information to be transmitted from the social media system to the account provider system. Also, the social linking API may allow subscriber relationship data to be transmitted to the account provider system if a social media subscriber opts-in to allow relationship data to be provided to the account provider system. Social linking API may allow subscriber social data to be transmitted to the account provider system. Subscriber social data may include likes & preferences, profile data, status updates, geo-social data, and event data.

By linking the social media system with the account provider system, an account holder authorizes the social media system to transmit certain subscriber data, such as subscriber location data, from the social media system to the account provider system.

Once a user has linked social media and financial accounts, the financial account provider system may determine probable financial offer categories based on social media data (step 506). For example, financial offer categories may include auto loan offers, credit card offers, home loan offers, reward offers, membership offers, investment offers, and the like. By way of example, auto loan offers may be determined by social media data such as social media postings about automobiles, social media preferences associated with automobiles and/or automobile manufacturers, social media profile data (e.g., preference data, event data, social media link data, photo data, and the like) associated with NASCAR, automobile shows, automobiles, and the like. By way of example, a financial category of credit card offers may be determined by associated social media data (e.g., postings, preferences, event, photo data, social media link data, and the like) about purchases, vendor websites, products, services, location data, and the like.

At step 508, a financial institution may detect the location of a user device. The user device may provide location data in the form of GPS coordinate data, Assisted GPS (A-GPS) data, geo-magnetic data, IP address data, cell tower data, Wi-Fi access point signals, additional Wi-Fi signal data, device-to-device technology data (e.g., RFID transceiver data, NFC data, Bluetooth data and/or iBeacon data) and/or any combination of the above (e.g., crowd-sourced positioning data). In various embodiments, a financial institution may detect the presence of a user device using device-to-device technology, such as RFID transceivers, NFC, Bluetooth and/or iBeacon. In various embodiments, financial account provider system may compare the location of the user device with location data associated with the financial institution (e.g., GPS coordinates, address data, geo-magnetic data, and the like). If the location comparison indicates that the user device is within a certain proximity of the financial institution, financial account provider system may detect that the user device is at the financial institution.

At step 510, financial account provider system may determine one or more financial offers out of the probable financial offer categories based on social media data associated with the detected account holder device. For example, financial account provider system may compare social media data and linked financial account data associated with the detected account holder device with stored data in order to determine a financial offer category, service, and/or product to share with an account holder before the account holder provides any data to the current financial institution.

At step 512, the financial account provider system may generate a notification to the financial institution based on the one or more determined offers. The notifications may be generated to provide information such as the name of an account holder, a description of accounts associated with the account holder, personally identifying information (such as a photo), social media data (such as recent events in his life, preferences, status updates, etc.), and the one or more determined offers based on the social media data and financial data (e.g., account data).

The generated notification may be transmitted to a financial institution device at step 514. A notification may be transmitted in the form of an electronic message, push notification, email, text message, SMS, MMS, voice message, or the like. At step 516, the financial account provider system may receive an account holder response to the one or more financial offers. This response may be transmitted via the financial institution device and/or the account holder device. The response may include an acceptance of the offer, a rejection of the offer, and/or a counter-offer.

At step 518, the financial account provider system may generate and transmit a communication to the account holder based on the account holder response. For example, a communication may include offer details, instructions to sign up for the offer, a response to the counter-offer, a counter-offer, a follow-up offer, and/or an acknowledgement of an acceptance, rejection, and/or counter-offer.

The method may end at step 520.

It should be appreciated that the foregoing discussion related to FIGS. 1 through 5 is illustrative only, and that the various embodiments of the disclosure may be implemented by any other appropriate system or method.

In the preceding specification, various preferred embodiments have been described with references to the accompanying drawings. It will, however, be evident that various modifications and changes may be made thereto, and additional embodiments may be implemented, without departing from the broader scope of the invention as set forth in the claims that follow. The specification and drawings are accordingly to be regarded as an illustrative rather than restrictive sense.

I claim:

1. A method, comprising:
receiving, at a customer service system, a request from a customer device to link a social media account and at least one customer device with the customer service system;
linking, using a social liking application programming interface that enables a social network system to interact with the customer service system, the customer device to the social media account;
detecting, using the customer service system, the at least one linked customer device when the at least one customer device is within a predetermined range of a customer service device associated with the customer service system;
generating, at the customer service system, a notification based on the customer device being within a predetermined range of the customer service device;
analyzing, using the social linking application programming interface, the linked social media account to determine at least one customer interest;
generating, at the customer service system, a listing of customer service offers based on the at least one customer interest; and
automatically providing at least one of the customer service offers to the customer device.

2. The method of claim 1, wherein the customer device is executing a mobile application associated with the customer service system.

3. The method of claim 1, wherein the detecting includes establishing a bluetooth low energy connection with the customer device.

4. The method of claim 1, wherein the customer service system includes a bluetooth low energy base station.

5. The method of claim 2, wherein the at least one of the customer service offers is automatically provided to the customer device via the mobile application.

6. The method of claim 1, wherein the analyzing determines at least one customer interest based on data provided by the customer to a social network.

7. The method of claim 3, wherein the customer device is executing a mobile application associated with the customer service system and the detecting includes retrieving data associated with the mobile application to identify the customer.

8. The method of claim 1, further comprising:
notifying a user of the customer service system that the at least one linked customer device has been detected.

9. The method of claim 8, wherein the notifying includes transmitting a notification that includes information about the customer and the at least one customer service offer provided to the customer.

10. The method of claim 9, wherein the notification includes information about the customer that is received via the social linking application programming interface.

11. A system, comprising:
a communication interface of a customer service system that receives, via a network, a request from a customer device to link a social media account and at least one customer device with the customer service system;
a social linking application programming interface that enables a social network system to interact with the customer service system and links the customer device to the social media account;
a database that stores the link between the customer device and the social media account;
a location detector that detects the at least one linked customer device when the at least one customer device is within a predetermined range of a customer service device associated with the customer service system;
an alert system that generates a notification based on the customer device being within a predetermined range of the customer service device; and
a processor that interacts with the social linking application programming interface analyzes the linked social media account to determine at least one customer interest and generate a listing of customer service offers based on the at least one customer interest,
wherein the alert system automatically provides at least one of the customer service offers to the customer device.

12. The system of claim 11, wherein the customer device executes a mobile application associated with the customer service system.

13. The system of claim 11, wherein the wherein the location detector establishes a bluetooth low energy connection with the customer device.

14. The system of claim 11, wherein the customer service system includes a bluetooth low energy base station.

15. The system of claim 12, wherein alert system automatically provides the at least one of the customer service offers to the customer device via the mobile application.

16. The system of claim 11, wherein the processor determines at least one customer interest based on data provided by the customer to a social network.

17. The system of claim 13, wherein the customer device executes a mobile application associated with the customer service system and the processor retrieves data associated with the mobile application to identify the customer.

18. The system of claim 11, wherein the alert system notifies a user of the customer service system that the at least one linked customer device has been detected.

19. The system of claim 18, wherein the notification includes information about the customer and the at least one customer service offer provided to the customer.

20. The system of claim 19, wherein the notification includes information about the customer that is received via the social linking application programming interface.
